(19) United States
(12) Patent Application Publication
(10) Pub. No.: US 2025/0232465 A1
(43) Pub. Date: Jul. 17, 2025

(54) METHOD FOR DETECTING OBJECTS IN IMAGE DATA

(71) Applicant: Robert Bosch GmbH, Stuttgart (DE)

(72) Inventor: Markus Spies, Karlsruhe (DE)

(21) Appl. No.: 19/008,247

(22) Filed: Jan. 2, 2025

(30) Foreign Application Priority Data
Jan. 12, 2024 (DE) 10 2024 200 275.5

(51) Int. Cl. G06T 7/70; B25J 9/16; G06T 7/11

(52) U.S. Cl. CPC G06T 7/70; B25J 9/1669; B25J 9/1697; G06T 7/11

(57) ABSTRACT

A method for detecting objects in image data. The method includes: segmenting an input image into a plurality of image regions, each image region showing a respective instance of a respective object type or an image background; ascertaining at least one group of the image regions showing instances of the same object type according to an image region similarity level; for each ascertained group, combining the instances of the object type that the image regions of the group show into a model for the object type; and detecting further instances of the object type or other objects in the input image or in one or more further input images on the basis of the model.

### CROSS REFERENCE

The present application claims the benefit under 35 U.S.C. § 119 of Germany Patent Application No. DE 10 2024 200 275.5 filed on Jan. 12, 2024, which is expressly incorporated herein by reference in its entirety.

### FIELD

The present invention relates to methods for detecting objects in image data.

### BACKGROUND INFORMATION

Picking up (i.e., gripping) an object from a container is an important problem in robotics. In order to be able to do this automatically, a robot must in particular be able to detect the object to be gripped, for example in order to select the correct object when different objects (e.g., screws and nuts) are present in the container, or also in order to distinguish an object from an undesirable object (e.g., packaging material residue). Accordingly, reliable object detection methods are desirable, in particular for scenes in which multiple instances of the same object type (i.e., identical objects, e.g., the same screw multiple times) are present.

### SUMMARY

According to various example embodiments of the present invention, a method for detecting objects in image data is provided, comprising:
segmenting an input image into a plurality of image regions, each image region showing a respective instance of a respective object type or an image background;
ascertaining at least one group of the image regions showing instances of the same object type according to an image region similarity level;
for each ascertained group, combining the instances of the object type that the image regions of the group show into a model for the object type; and
detecting further instances of the object type or other objects in the input image or in one or more further input images on the basis of the model.

The method described above makes it possible to reliably detect objects for use cases in which multiple identical objects (i.e., multiple instances of the same object type) are present.

Segmenting is carried out, for example, by means of a machine learning model trained for segmenting image data.

By using a (modern, machine-learning-based) object segmentation model (e.g., a neural network, e.g., a convolutional neural network) in the first step, object understanding is achieved, which is typically not the case with methods based merely on local features. This improves applicability in real-world scenarios in which objects can be captured under different viewing angles or light conditions.

Various exemplary embodiments of the present invention are specified below.

Exemplary embodiment 1 is a method for detecting objects in image data as described above.

Exemplary embodiment 2 is a method according to exemplary embodiment 1, wherein ascertaining the at least one group comprises, for each pair of image regions, ascertaining a value of the image region similarity level, and ascertaining a maximum clique, wherein two image regions are considered to be connected if the image region similarity level between them is above a specified threshold value.

Groups of image regions showing instances of the same object type can thus be ascertained effectively. For example, the similarity level is a distance measurement between features of the image regions and/or a degree of matching of sets of local features (keypoints), such as in the case of SIFT (scale-invariant feature transform).

Exemplary embodiment 3 is a method according to exemplary embodiment 1 or 2, comprising ascertaining multiple groups of the image regions showing instances of the same respective object type according to the image region similarity level, comparing the numbers of the image regions that belong to the groups, and ascertaining, as objects to be manipulated, the instances of that object type that are shown by the image regions of the group containing the most image regions.

For example, objects to be manipulated (e.g., objects to be removed from a container) may thus be differentiated from debris (e.g., packaging material residues).

Exemplary embodiment 4 is a method according to one of exemplary embodiments 1 to 3, wherein the model is a two-dimensional or three-dimensional model of the design of objects of the object type.

Further possible instances of the object type can then be compared therewith in order thus to improve the detection accuracy for the further instances. In particular, it is also possible to find instances that were initially “overlooked” during the segmentation.

Exemplary embodiment 5 is a method according to one of exemplary embodiments 1 to 4, wherein detecting another object in the input image or in the one or more further input images on the basis of the model is identifying objects that differ from the object type, on the basis of the model.

For example, “another object” is an anomaly or an outlier, such as a defective object of the object type. By creating the model, such anomalies (e.g., defective objects) can be identified effectively without knowing the object type in advance.

Exemplary embodiment 6 is a method for controlling a technical system, comprising detecting one or more objects according to one of exemplary embodiments 1 to 5, and controlling the technical system for manipulating the one or more detected objects.

Exemplary embodiment 7 is a data processing unit (in particular, control unit) configured to carry out a method according to one of exemplary embodiments 1 to 6.

Exemplary embodiment 8 is a computer program comprising instructions that, when executed by a processor, cause said processor to carry out a method according to one of exemplary embodiments 1 to 6.

Exemplary embodiment 9 is a computer-readable medium which stores instructions that, when executed by a processor, cause said processor to carry out a method according to one of exemplary embodiments 1 to 6.

In the figures, like reference signs generally refer to the same parts throughout the different views. The figures are not necessarily to scale, emphasis being instead generally placed on representing certain principles of the present invention. Various aspects are described in the following description with reference to the figures.

### BRIEF DESCRIPTION OF THE DRAWINGS

FIG. 1 shows a robot according to an example embodiment of the present invention.

FIG. 2 illustrates the creation of an object model from an input image, according to an example embodiment of the present invention.

FIG. 3 shows a flowchart illustrating a method for detecting objects in image data according to an example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented. Other aspects may be used, and structural, logical, and electrical changes may be carried out without departing from the scope of the present invention. The various aspects of this disclosure are not necessarily mutually exclusive since some aspects of this disclosure can be combined with one or more other aspects of this disclosure to form new aspects.

Various examples are described in more detail below.

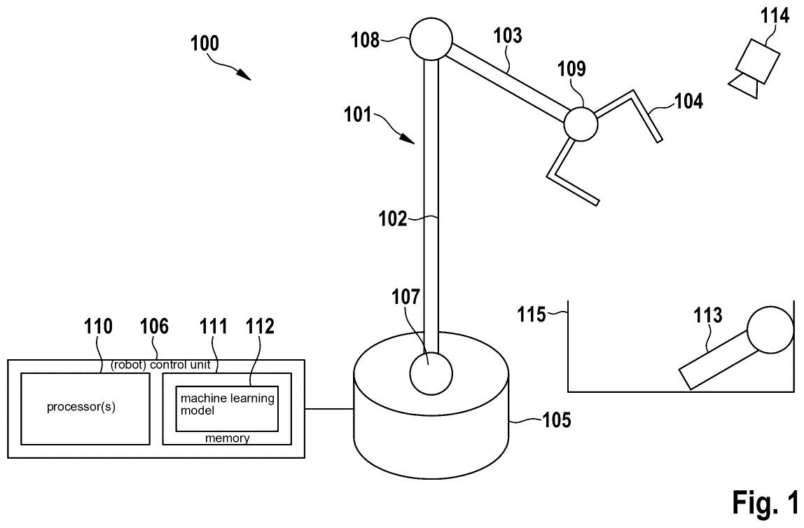

FIG. 1 shows a robot 100.

The robot 100 comprises a robotic arm 101, for example an industrial robotic arm for handling or mounting a workpiece (or one or more other objects). The robotic arm 101 comprises manipulators 102, 103, 104 and a base (or support) 105 by means of which the manipulators 102, 103, 104 are supported. The term “manipulator” refers to the movable elements of the robotic arm 101, the actuation of which makes physical interaction with the environment possible, for example in order to perform a task. For controlling, the robot 100 comprises a (robot) control unit 106 configured to implement the interaction with the environment according to a control program. The last element 104 (which is farthest from the support 105) of the manipulators 102, 103, 104 is also referred to as the end effector 104 and may comprise one or more tools, such as a welding torch, a gripper, a painting tool, or the like.

The other manipulators 102, 103 (which are closer to the support 105) can form a positioning device so that, together with the end effector 104, the robotic arm 101 is provided with the end effector 104 at its end. The robotic arm 101 is a mechanical arm that may provide functions similar to those of a human arm (possibly with a tool at its end).

The robotic arm 101 may comprise articulation elements 107, 108, 109 which connect the manipulators 102, 103, 104 to one another and to the support 105. An articulation element 107, 108, 109 may comprise one or more articulation joints, which may each provide a rotary movement (i.e., rotational movement) and/or translatory movement (i.e., displacement) for associated manipulators relative to one another. The movement of the manipulators 102, 103, 104 may be initiated by means of actuators controlled by the control unit 106.

The term “actuator” may be understood to mean a component designed to influence a mechanism or process in response to being driven. The actuator may implement instructions, which are output by the control unit 106 (so-called activation), as mechanical movements. The actuator, e.g., an electromechanical converter, may be configured to convert electrical energy into mechanical energy in response to being activated.

The term “control unit” may be understood to mean any type of logic implemented by an entity which may comprise, for example, a circuit and/or a processor which is capable of executing software stored in a storage medium, firmware, or a combination thereof, and which can issue instructions, e.g., to an actuator in the present example. For example, the control unit may be configured by program code (e.g., software) to control the operation of a robotic device.

In the present example, the control unit 106 comprises one or more processors 110 and a memory 111, which stores code and data on the basis of which the processor 110 controls the robotic arm 101. According to various embodiments, the control unit 106 controls the robotic arm 101 on the basis of a machine learning model 112, which is stored in the memory 111, and sensor data, e.g., image data from a camera 114 (these may be color images (RGB) but may also have depth information (RGB-D)). For example, the robot 100 is to manipulate an object 113. For example, the manipulation task is to pick up an object 113, e.g., from a container 115 (so-called bin picking).

In many use cases (especially in logistics), recurring objects of the same type occur, i.e., multiple instances of the same object type (or, in other words, the same object multiple times). For example, the container 115 contains multiple identical objects (i.e., instances of the same object type, e.g., multiple identical screws) that need to be removed for further processing.

The information that an object repeatedly appears in a particular scene (i.e., multiple instances of the same object type) can be used for more robust perception. For example, if another object is also contained in the container 115 (e.g., packaging material residue), it can be inferred that this is not the object to be picked up, on the basis of the fact that only one instance (or a few instances) of the other object are present.

According to various embodiments, an object detection method is provided, in which the detection accuracy is improved by obtaining information about an object from multiple instances of the object.

To this end, according to various embodiments, a foundation model (which corresponds to the machine learning model 112, for example) is used to find object suggestions in input data (e.g., in an input image), e.g., a segmentation model such as Segment Anything (SAM). On the basis of the object suggestions (i.e., ascertained image regions that each show a respective object), instances of the same object type are then searched by ascertaining object suggestions that have a similar appearance, e.g., by searching for patterns (e.g., on the basis of low-level features such as edges or pixel values) that are present in multiple of the object suggestions. This allows for better object understanding and thus ultimately improved detection accuracy in open-world scenarios.

According to various embodiments, in a first step, object suggestions are thus ascertained by means of an ML (machine learning) foundation model and, in a second step, object suggestions are compared to one another, for example by searching for respective transforms for pairs of object suggestions that map them to one another so that clusters of similar object suggestions, i.e., groups of instances of the same object type that are represented from different viewing angles in the input image, for example, or that are exposed to different light conditions, are formed. In a third step, the various instances of the object can be combined in order to create a model (or template) for the object.

For the first step, any (e.g., open-world) object segmentation method may be used, i.e., a method that provides a list of object masks, for example in the case of an RGB input image or RGB-D input image, ideally mask one for each instance of one or more (physical) objects in the input image. It is assumed that the object segmentation method is capable of providing a mask for each object (that is of interest) in the corresponding scene.

The second step is to filter out object instances belonging to the same object type (i.e., identical objects). Typically, an object segmentation method provides many object suggestions, including for the background. For example, in the second step, a method based on local features, and a homography estimate (i.e., a calculation of possible transforms from one object suggestion to the other for pairs of object suggestions) are used to obtain pairwise ratings for how similar two object suggestions are. For example, these ratings could be represented as a graph (i.e., the nodes correspond to object suggestions and each edge between two object suggestions of a pair has the corresponding rating of the pair). In such a graph, it is possible to search for maximum cliques, i.e., object groups or clusters, i.e., groups for which there is a transform (with certain limitations) between the two object suggestions for each pair of object suggestions (i.e., an image region similarity level is above a specified threshold value). The object suggestions of such a maximum clique are considered to be instances of the same object type (i.e., identical objects).

In the third step, the individual object instances of a group are combined into a model or an object template. For example, the full shape of the object is produced from the different viewing angles that provide the object suggestions of the corresponding group, by combining, e.g., merging, the parts (object suggestions). Depending on the input modality, this can be done in the 2D RGB space or in the 3D space, e.g., using point clouds. For both modalities, different methods of adjusting multiple portions of an object are available.

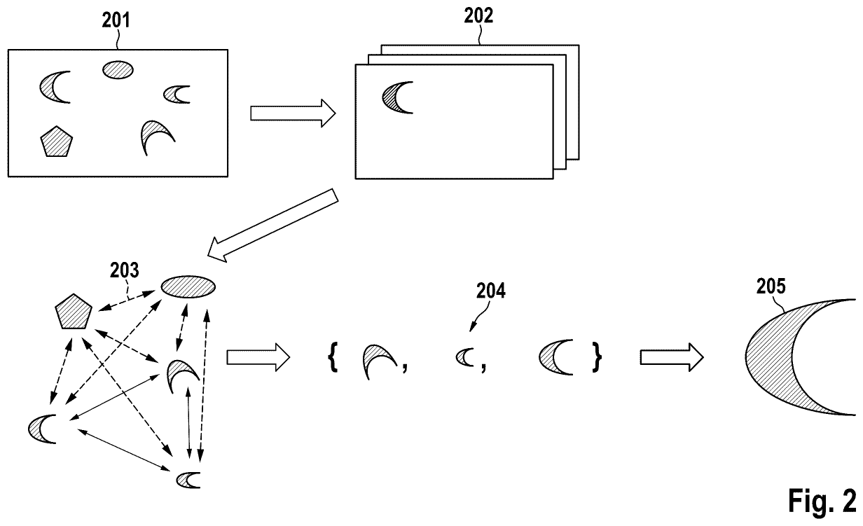

FIG. 2 illustrates the creation of an object model 205 from an input image 201.

The input image 201 is first transmitted to the object segmentation method (e.g., SAM). The output of this method is a list 202 of N object masks in the image (e.g., a list of binary images with ones at the position of the corresponding object).

The object mask list is then passed to a matching stage. Here, a pairwise matching score (i.e., the value of a similarity level, i.e., a similarity rating) is calculated between the object suggestions of all N2 pairs of object suggestions. To this end, a method for ascertaining local features may be used, such as a classic computer vision method such as SIFT (scale-invariant feature transform) or another method based on local features. On the basis of the local features, for each pair of object suggestions, a homography can be estimated between the two object suggestions. In so doing, a transform (shift, rotation, scale, shear) from one object suggestion to the other is estimated. For example, the estimated transform is stored along with the similarity rating in an N×N affinity matrix, which can be represented as a graph 203, as explained above.

From the affinity matrix, one or more contiguous clusters, i.e., one or more groups of objects, all of which are similar in pairs, are calculated. In practice, it is possible for this purpose to first define a threshold value for similarity ratings in the affinity matrix (i.e., the edge weights of the graph) and thus to convert it into a binary matrix containing ones (for similarity ratings greater than the threshold) and zeros (for similarity ratings less than the threshold) (equality with the threshold may be rated as one or as zero depending on the definition). A one at a matrix location means that there is a transform between the two object suggestions with these indices, which in turn means that they show instances of the same object type, e.g., from different viewing angles (shown in FIG. 2 as a solid edge of the graph 203). A zero means that this is not the case (shown in FIG. 2 as a dashed edge of the graph 203).

Maximum cliques, i.e., sets of object suggestions, all of which are similar in pairs, can be ascertained in the matrix or the graph 203. The result of this phase is a list of clusters (in this example, only one cluster 204), wherein each cluster consists of object suggestions (or object masks) of the same object type (i.e., identical objects) (wherein only clusters containing multiple object suggestions are considered, for example).

For example, 2D image stitching methods or 3D point cloud matching methods may now be used to create an object model 205 from each cluster 204. This may be used for subsequent tasks such as calculating a gripping pose or detecting anomalies.

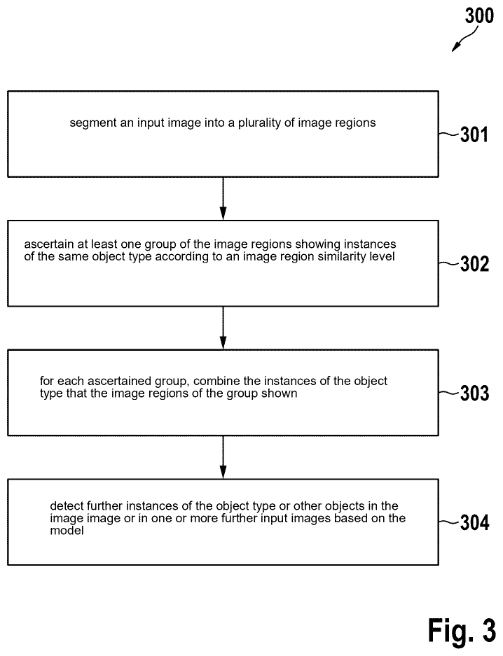

In summary, a method is provided according to various embodiments, as shown in FIG. 3.

FIG. 3 shows a flowchart 300 illustrating a method for detecting objects in image data, according to an embodiment.

In 301, an input image is segmented into a plurality of image regions, wherein each image region shows a respective instance of a respective object type or an image background (wherein certain objects may also be attributed to the image background, e.g., objects which are of no interest in the particular use case or which are only solely present).

In 302, at least one group of the image regions showing instances of the same object type according to an image region similarity level is ascertained (i.e., a similarity between image regions is ascertained and, if it is above a certain threshold value, this is interpreted such that the image regions show instances of the same object type, i.e., show the same object).

In 303, for each ascertained group, the instances of the object type that the image regions of the group show are combined into a model (pattern, template) for the object type.

In 304, further instances of the object type or other objects in the input image or in one or more further input images are detected (or identified) on the basis of the model.

For example, as described above, the procedure of FIG. 3 may be used in the event that multiple instances of the same object type are present in a container 115 and a robot 100 must find individual instances for removal. However, it may also be used for other use cases in which sensor data, in particular those that can be represented as image data, i.e., in general, in matrix form with one or more channels, and that represent multiple instances of the same object type which are of interest, e.g., for counting instances, for finding outliers, and for quality assurance, etc. The sensor data may be or contain not only color images and depth images but also image data (i.e., data arranged in matrix form) from various other sensors, e.g., radar, LiDAR, ultrasound, motion, thermal imaging, etc.

For example, anomalies in a technical system may be detected in the following manner: Knowledge of multiple instances of an object in a scene and the resulting model of the object (i.e., a “correct” object appearance) can be used to detect an anomaly on the basis of the one or more objects deviating from the model (e.g., a broken screw, which is, for example, missing the head, in the container 115 does not match the model, i.e., the expected appearance). Undamaged parts may thus be used, for example, to create a model as to what an object should look like, and damaged parts can be detected on the basis of them not matching the model.

The procedure of FIG. 3 may be part of a pipeline in which it provides object (model) information, such as the (expected) geometry or the (expected) appearance of each object. This information may then be used for further processing, for example for controlling a robot or other technical system, such as a computer-controlled machine, a vehicle, a household appliance, an electric tool, a manufacturing machine, a personal assistant, or an access control system. For example, one of the object instances is located on the basis of the corresponding sensor data (e.g., the location of a screw in the container 115 is ascertained and the robotic arm 101 is controlled to grip the screw).

Individual instances can also be tracked on the basis of low-level features in the sensor data (e.g., in a video, i.e., a sequence of images).

The method of FIG. 3 can be performed by one or more computers comprising one or more data processing units. The term “data processing unit” may be understood to mean any type of entity that makes the processing of data or signals possible. The data or signals may, for example, be processed according to at least one (i.e., one or more than one) specific function carried out by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate assembly (FPGA), or any combination thereof. Any other way of implementing the particular functions described in more detail here can also be understood as a data processing unit or logic circuit arrangement. One or more of the method steps described in detail here can be performed (e.g., implemented) by a data processing unit by means of one or more specific functions carried out by the data processing unit.

According to various embodiments, the method is thus, in particular, computer-implemented.

What is claimed is:

1. A method for detecting objects in image data, comprising the following steps:
segmenting an input image into a plurality of image regions, each of the image regions showing a respective instance of a respective object type or an image background;
ascertaining at least one group of the image regions showing instances of the same object type according to an image region similarity level;
for each ascertained group, combining the instances of the object type that the image regions of the group show into a model for the object type; and
detecting, based on the model, further instances of the object type or other objects, in the input image or in one or more further input images.

2. The method according to claim 1, wherein the ascertaining of the at least one group includes, for each pair of the image regions, ascertaining a value of the image region similarity level, and ascertaining a maximum clique, wherein two image regions are considered to be connected when the image region similarity level between them is above a specified threshold value.

3. The method according to claim 1, further comprising ascertaining multiple groups of the image regions showing instances of the same respective object type according to the image region similarity level, comparing numbers of the image regions that belong to the groups, and ascertaining, as objects to be manipulated, the instances of that object type that are shown by the image regions of the group containing the most image regions.

4. The method according to claim 1, wherein the model is a two-dimensional or three-dimensional model of a design of objects of the object type.

5. The method according to claim 1, wherein detecting another object in the input image or in the one or more further input images based on the model includes identifying objects that differ from the object type, based on the model.

6. A method for controlling a technical system, comprising:
detecting one or more objects in image data, including:
segmenting an input image into a plurality of image regions, each of the image regions showing a respective instance of a respective object type or an image background,
ascertaining at least one group of the image regions showing instances of the same object type according to an image region similarity level,
for each ascertained group, combining the instances of the object type that the image regions of the group show into a model for the object type, and
detecting, based on the model, further instances of the object type or other objects, in the input image or in one or more further input images; and
controlling the technical system for manipulating the one or more detected objects.

7. A data processing unit configured to detect objects in image data, the data processing unit configured to:
segment an input image into a plurality of image regions, each of the image regions showing a respective instance of a respective object type or an image background;
ascertain at least one group of the image regions showing instances of the same object type according to an image region similarity level;
for each ascertained group, combine the instances of the object type that the image regions of the group show into a model for the object type; and
detect, based on the model, further instances of the object type or other objects, in the input image or in one or more further input images.

8. A non-transitory computer-readable medium on which is stored instructions for detecting objects in image data, the instructions, when executed by a processor, causing the processor to perform the following steps:
segmenting an input image into a plurality of image regions, each of the image regions showing a respective instance of a respective object type or an image background;
ascertaining at least one group of the image regions showing instances of the same object type according to an image region similarity level;
for each ascertained group, combining the instances of the object type that the image regions of the group show into a model for the object type; and
detecting, based on the model, further instances of the object type or other objects, in the input image or in one or more further input images.
